(19) United States
(12) Patent Application Publication
(10) Pub. No.: US 2024/0286399 A1
(43) Pub. Date: Aug. 29, 2024

(54) FOIL TRANSFER DEVICE

(71) Applicant: MIMAKI ENGINEERING CO., LTD., Nagano (JP)

(72) Inventors: Katsutoshi Yamabe, Nagano (JP); Akihiko Mizusaki, Nagano (JP); Takehiro Imai, Nagano (JP)

(73) Assignee: MIMAKI ENGINEERING CO., LTD., Nagano (JP)

(21) Appl. No.: 18/572,147

(22) PCT Filed: Jul. 13, 2022
(86) PCT No.: PCT/JP2022/027519

§ 371 Date: Dec. 19, 2023

(30) Foreign Application Priority Data
Jul. 19, 2021 (JP) 2021-118745
Jul. 19, 2021 (JP) 2021-118746
Jul. 19, 2021 (JP) 2021-118747

(51) Int. Cl. B41F 16/00; B65H 23/04; B65H 41/00

(52) U.S. Cl. CPC B41F 16/0026; B41F 16/0093; B65H 23/04; B65H 41/00; B65H 2301/5113; B65H 2404/10

(57) ABSTRACT

A foil transfer device having a reduced size is provided. The foil transfer device includes an adhesive application mechanism that applies an adhesive to a medium, and a transfer roller pair that presses a foil transfer sheet against the medium to which the adhesive is applied to transfer the foil to the medium. The adhesive application mechanism includes a head that ejects an adhesive onto the medium, and a platen that is disposed on the lower side of the head and on which the medium is mounted. In the foil transfer device, the transfer roller pair is disposed on the lower side of the platen.

### TECHNICAL FIELD

The present invention relates to a foil transfer device that transfers a foil to a medium.

### BACKGROUND ART

A foil transfer device for transferring a foil to a long medium is known (see e.g., Patent Literature 1.). The foil transfer device includes an inkjet head that ejects an adhesive liquid onto a medium, and a foil transfer nip roller pair that presses a foil transfer sheet against the medium applied with the adhesive liquid. The foil transfer device further includes a supply roll that feeds out the medium and supplies the medium to the inkjet head, and a collection roll that winds and collects the medium to which the foil has been transferred in the foil transfer nip roller pair.

### CITATION LIST

### Patent Literature

Patent Literature 1: Japanese Unexamined Patent Publication No. 2009-226880

### SUMMARY OF INVENTION

### Technical Problems

In the foil transfer device described in Patent Literature 1, the inkjet head and the foil transfer nip roller pair are arranged side by side in the front-back direction between the supply roll and the collection roll, and thus the foil transfer device may be increased in size in the front-back direction, and a large installation area may be required.

It is required to reduce the size of the foil transfer device to reduce the area required for installation.

### Solutions to Problems

(1) A foil transfer device of the present invention includes: an application mechanism, configured to apply an adhesive to a medium; and a roller, configured to press a sheet in which a foil is formed on a substrate against the medium to which the adhesive is applied to transfer the foil to the medium; where the application mechanism includes: a head portion configured to eject the adhesive onto the medium, and a medium mounting portion configured to be disposed on a lower side of the head portion and on which the medium is mounted; and

the roller is disposed on a lower side of the medium mounting portion.

In the present invention, the foil transfer device can be downsized, and the area required for installation can be reduced. In the foil transfer device of the present invention, a roller is disposed on a lower side of a medium mounting portion on which a medium is mounted when applying an adhesive. That is, in the present invention, the position of the medium when the adhesive is applied and the position of the medium when the foil is transferred are shifted in the vertical direction. Therefore, in the present invention, it is possible to shift the region for applying the adhesive to the medium and the region for transferring the foil to the medium in the vertical direction. Therefore, in the present invention, the two regions can be brought close to each other in the front-back direction while preventing the region for applying the adhesive to the medium and the region for transferring the foil to the medium from interfering with each other. Therefore, in the present invention, the foil transfer device can be downsized in the front-back direction, and as a result, the installation area of the foil transfer device can be reduced.

(2) In the present invention, for example, the roller includes a pair of rollers sandwiching the medium and the sheet, and the pair of rollers is arranged facing each other in a direction orthogonal to the vertical direction. By arranging the pair of rollers on the lower side of the medium mounting portion so as to face each other, the foil transfer sheet 3 can be overlapped without changing the moving direction of the medium 2 conveyed downward from the medium mounting portion, which contributes to reducing the size of the foil transfer device 1.

(3) In the present invention, the foil transfer device further includes: a medium feeding portion configured to feed the medium to the application mechanism, and a medium winding portion configured to wind the medium that has passed through the roller. For example, at least one of the medium feeding portion and the medium winding portion is disposed on the lower side of the application mechanism. In this case, as compared with a case where both the medium feeding portion and the medium winding portion are disposed at positions shifted from the lower side of the application mechanism, the foil transfer device can be further downsized in the front-back direction.

(4) In the present invention, it is preferable that, the foil transfer device further includes: a tension application mechanism, including a tension bar that comes into contact with a medium to which an adhesive has been applied and applies a tension to the medium, and the tension bar is disposed between the medium mounting portion and the transfer roller pair in the vertical direction and applies tension to the medium after the adhesive has been applied and before the foil is transferred. With such a configuration, since the tension bar is disposed between the medium mounting portion and the roller in the vertical direction, the foil transfer device can be downsized in the front-back direction even if the foil transfer device includes the tension bar.

According to such a configuration, the tension bar applies tension to the medium after the adhesive has been applied and before the foil is transferred, so that the tension bar suppresses variations in tension of the medium when the foil is transferred. Therefore, it is possible to prevent the foil from being transferred to the medium in a slack state or the foil from being transferred to the medium in a state where a large tension is applied. Thus, for example, the foil is transferred to the medium in a slack state, and as a result, occurrence of cracks in the foil when the medium after the foil is transferred is stretched can be suppressed. Furthermore, for example, the foil is transferred to the medium in a state where a large tension is applied, and as a result, generation of wrinkles in the foil when the tension of the medium after the foil is transferred is relaxed can be suppressed.

(5) In the present invention, the foil transfer device preferably further includes: a first heater and a second heater that heat the medium, the first heater is disposed above the tension bar, and the second heater is disposed between the tension bar and the roller in the vertical direction.

With this configuration, since the first heater is disposed on the upper side of the tension bar and the second heater is disposed between the tension bar and the transfer roller pair in the vertical direction, the foil transfer device can be downsized in the front-back direction even if the foil transfer device includes the first heater and the second heater. According to such configuration, even if the tension bar is arranged between the first heater and the roller, the adhesive force of the adhesive applied to the medium when reaching the roller can be enhanced by the second heater. Therefore, the foil can be appropriately transferred to the portion of the medium to which the adhesive is applied by the roller.

(6) In the present invention, for example, the foil transfer device further includes: a sheet feeding portion configured to feed the sheet to the roller, and a supporting body configured to support the medium mounting portion from below, where the sheet feeding portion is detachably attached to the supporting body. In this case, for example, the foil transfer device can be used as an inkjet printer by removing the sheet feeding portion from the supporting body and ejecting the ink from the head portion. Therefore, versatility of the foil transfer device can be enhanced.

(7) In the present invention, it is preferable that, the roller includes: a conveying roller that comes into contact with the medium and conveys the medium, and a transfer roller that is biased toward the conveying roller and sandwiches the medium and the sheet with the conveying roller, where the transfer roller is configured by a plurality of divided rollers divided in an axial direction of the transfer roller, and each of both end sides of the plurality of divided rollers is rotatably supported by a bearing. With this configuration, even if the width of the medium is wide, the deflection of the foil transfer roller when pressing the medium and the foil transfer sheet against the conveying roller can be suppressed. Therefore, even if the width of the medium is wide, the foil can be appropriately transferred to the portion of the medium to which the adhesive is applied by the roller.

(8) In the present invention, the foil transfer device preferably further includes: an intermediate supporting member configured to rotatably support an intermediate portion of the divided roller. With this configuration, even if the width of the medium is wide, the deflection of the transfer roller when pressing the medium and the foil transfer sheet against the conveying roller can be effectively suppressed. Therefore, even if the width of the medium is wide, the foil can be appropriately transferred to the portion of the medium to which the adhesive is applied by the roller.

(9) A foil transfer device of the present invention includes: an application mechanism configured to apply an adhesive to a medium; a roller configured to press a sheet in which a foil is formed on a base material against the medium to which the adhesive is applied to transfer the foil to the medium; and a tension application mechanism including a tension bar that comes into contact with the medium to apply tension to the medium, where the tension bar is disposed between the application mechanism and the roller.

In the foil transfer device of the present invention, the tension bar is disposed between the application mechanism and the roller, so that the foil transfer device can be downsized and the area required for installation can be reduced. The tension bar is disposed between the application mechanism and the roller, and applies tension to the medium after the adhesive is applied thereto and before the foil is transferred thereto. Thus, in the present invention, the tension bar suppresses variations in the tension of the medium when the foil is transferred. Therefore, in the present invention, it is possible to suppress the foil from being transferred to the medium in a slack state or the foil from being transferred to the medium in a state where a large tension is applied.

Thus, in the present invention, for example, the foil is transferred to the medium in a slack state, and as a result, it is possible to suppress the occurrence of cracks in the foil when the slack of the medium after the foil is transferred is removed. Furthermore, in the present invention, for example, the foil is transferred to the medium in a state where a large tension is applied, and as a result, it is possible to suppress generation of wrinkles in the foil when the tension of the medium after the foil is transferred is relaxed. That is, in the foil transfer device of the present invention, it is possible to suppress generation of cracks and wrinkles in the foil transferred to the medium.

(10) In the present invention, for example, the application mechanism includes a head portion that ejects an adhesive onto a medium.

(11) In the present invention, it is preferable that, the application mechanism is configured to apply the adhesive to one portion of one surface of the medium in a width direction of the medium, a non-application region where the adhesive is not applied in the width direction of the medium is formed on the one surface, the tension bar includes a contact portion that comes into contact with the non-application region and a bar main body holding the contact portion, and only the contact portion of the tension bar is in contact with the medium. With this configuration, even if the tension bar is in contact with the adhesive application surface, which is one surface of the medium, the adhesive applied to the medium can be prevented from attaching to the tension bar.

(12) In the present invention, for example, the medium before the adhesive is applied and the medium after the foil is transferred are wound in a roll shape, and the sheet before the foil is transferred to the medium is wound in a roll shape.

(13) In the present invention, it is preferable that, the foil transfer device further includes a direction changing roller configured to change a moving direction of the medium in a state of overlapping the sheet after passing through the roller, and the direction changing roller changes the moving direction of the medium in a direction different from the moving direction of the medium from the roller to the direction changing roller. With this configuration, the foil transfer device can be downsized in the moving direction of the medium immediately after passing through the roller as compared with the case where the direction changing roller is not provided.

(14) In the present invention, the medium and the sheet are preferably separated when passing through the direction changing roller. With such a configuration, since the medium and the sheet overlap each other between the roller and the direction changing roller, a space for moving the medium and the sheet can be reduced between the roller and the direction changing roller.

(15) A foil transfer device of the present invention includes: an application mechanism configured to apply an adhesive to a medium; a roller configured to press a sheet in which a foil is formed on a base material onto the medium to which the adhesive is applied to transfer the foil to the medium; and a direction changing roller configured to change a moving direction of the medium in a state of overlapping the sheet after passing through the roller, where the direction changing roller changes the moving direction of the medium to a direction different from the moving direction of the medium from the roller to the direction changing roller.

In the present invention, the foil transfer device can be downsized, and the area required for installation can be reduced. In the foil transfer device of the present invention, the moving direction changing roller for changing the moving direction of the medium in a state of overlapping the sheet after passing through the roller changes the moving direction of the medium to a direction different from the moving direction of the medium from the roller to the direction changing roller. Therefore, in the present invention, as compared with a case where the direction changing roller is not provided, the foil transfer device can be downsized in the moving direction of the medium immediately after passing through the roller.

(16) In the present invention, the foil transfer device further includes, for example, a first changing roller configured to bend the medium in a predetermined direction as the direction changing roller.

(17) In the present invention, a diameter of the first changing roller is preferably greater than or equal to two inches. According to such configuration, even if the medium is bent in the predetermined direction by the first changing roller, the occurrence of cracks of the foil transferred to the medium can be suppressed.

(18) In the present invention, a diameter of the first changing roller is preferably greater than or equal to three inches. According to such configuration, even if the medium is bent in the predetermined direction by the first changing roller, the occurrence of cracks of the foil transferred to the medium can be more effectively suppressed.

(19) In the present invention, for example, the foil transfer device further includes, as the direction changing roller, a second changing roller configured to guide the medium after passing through the first changing roller in a predetermined direction, and the medium and the sheet are separated when passing through the second changing roller. In this case, since the medium and the sheet overlap each other between the roller and the second changing roller, a space for moving the medium and the sheet can be reduced between the roller and the second changing roller.

(20) In the present invention, the foil transfer device preferably further includes a guide roller configured to guide the sheet that has passed through the second changing roller and separated from the medium in a predetermined direction. With this configuration, the sheet separated from the medium can be appropriately guided in a predetermined direction.

(21) In the present invention, the medium in a state of overlapping the sheet is preferably in contact with the outer peripheral surface of the second changing roller. With this configuration, the medium and the foil transfer sheet are separated at a position where the foil transfer sheet separates from the second changing roller. Therefore, for example, even when the medium to which the foil has been transferred is wound in a roll shape and the outer diameter of the medium wound in the roll shape fluctuates, the medium and the foil transfer sheet can be separated at a certain position.

(22) In the present invention, when viewed from a width direction of the medium, it is preferable that, the medium separated from the sheet linearly extends in a predetermined direction from the second changing roller, the sheet separated from the medium linearly extends in a predetermined direction from the second changing roller, and an angle formed by the separated medium and the sheet is an acute angle. According to the study of the inventor of the present application, with such a configuration, the foil can be appropriately transferred to the portion of the medium to which the adhesive is applied.

(23) In the present invention, the angle formed by the separated medium and sheet when viewed from the width direction of the medium is more preferably less than or equal to 60°. According to the study of the inventor of the present application, with such a configuration, the foil can be more appropriately transferred to the portion of the medium to which the adhesive is applied.

(24) In the present invention, the medium and the sheet may be separated when passing through the first changing roller. In this case, since the medium and the sheet overlap each other between the roller and the first changing roller, a space for moving the medium and the sheet can be reduced between the roller and the first changing roller.

(25) In the present invention, the medium in a state of overlapping the sheet is preferably in contact with the outer peripheral surface of the first changing roller. According to such configuration, the medium and the sheet are separated at the position where the sheet separates from the first changing roller. Therefore, for example, even when the medium to which the foil has been transferred is wound in a roll shape and the outer diameter of the medium wound in the roll shape fluctuates, the medium and the foil transfer sheet can be separated at a certain position.

### Effect of the Invention

As described above, the foil transfer device of the present invention can be downsized in the front-back direction, and the area required for installing the foil transfer device can be reduced.

### BRIEF DESCRIPTION OF THE DRAWINGS

FIG. 1 is a side view for explaining a configuration of a foil transfer device according to an embodiment of the present invention.

FIG. 2 is a view showing an adhesive application surface which is one surface of the medium shown in FIG. 1.

In FIG. 3, (A) is a front view for explaining the configuration of the transfer roller pair shown in FIG. 1, and (B) is a side view for explaining the configuration of the transfer roller pair shown in FIG. 1.

FIG. 4 is a side view for explaining the configuration of the tension application mechanism shown in FIG. 1.

FIG. 5 is a cross-sectional view for explaining the configuration of the tension bar shown in FIG. 4.

FIG. 6 is a diagram for explaining the sensors that detect the position of the tension bar shown in FIG. 4.

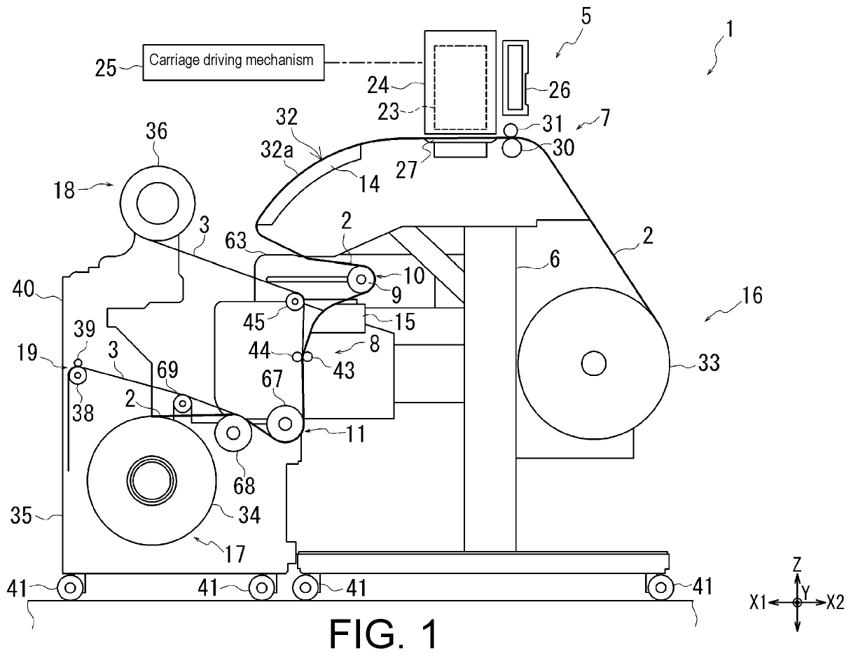

In FIG. 7, (A) is a side view for explaining a configuration of a moving direction changing portion shown in FIG. 1, and (B) is an enlarged view of portion E in (A).

### DESCRIPTION OF EMBODIMENTS

Hereinafter, embodiments of the present invention will be described with reference to the drawings.

### (Overall Configuration of Foil Transfer Device)

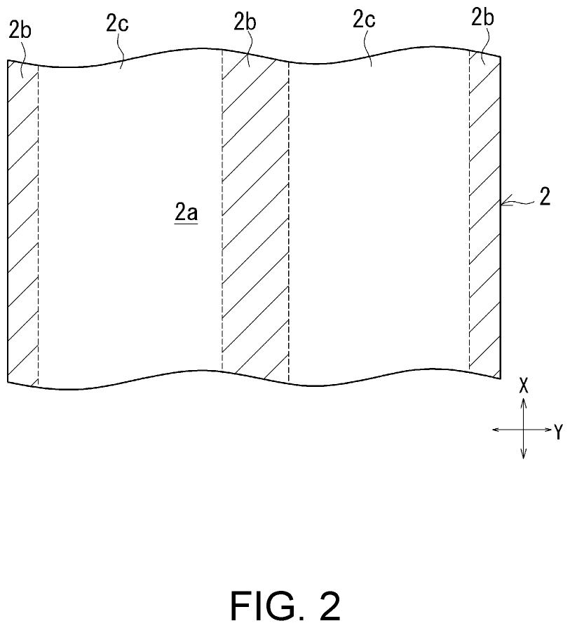

FIG. 1 is a side view for explaining a configuration of a foil transfer device 1 according to an embodiment of the present invention. FIG. 2 is a view showing an adhesive application surface 2a which is one surface of a medium 2 shown in FIG. 1.

In the following description, the “Z direction” illustrated in FIG. 1 means a “vertical direction” based on a state in which the foil transfer device 1 is mounted on a horizontal plane. A “Y direction” that is orthogonal to the vertical direction and that lies along the width direction of the medium 2 mounted on the foil transfer device 1 is defined as a “left-right direction” of the foil transfer device 1. Furthermore, an “X direction” that is orthogonal to the “vertical direction” and the “left-right direction” is defined as a “front-back direction” of the foil transfer device 1. An X1 side which is one side in the front-back direction is referred to as a “front” side, and an X2 side which is the other side is referred to as a “back” side.

As shown in FIG. 1, the foil transfer device 1 of the present embodiment is a device that transfers a foil (metal foil) onto a medium 2. The foil transfer device 1 presses a foil transfer sheet 3 (sheet) having a foil formed on a base material onto the medium 2 applied with an adhesive to transfer the foil to the medium 2. The foil transfer device 1 continuously applies an adhesive to the medium 2 and continuously transfers the foil to the medium 2. The medium 2 is long and wound in a roll shape before the adhesive is applied and after the foil is transferred. In addition, the foil transfer sheet 3 is long, and is wound in a roll shape before the foil is transferred to the medium 2.

The medium 2 is a sheet-like medium made of synthetic resin or paper. When the tensile elasticity of the medium 2 is low, the medium 2 is likely to stretch when tension acts on the medium 2. When tension acts on the medium 2 of after the foil is transferred and the medium 2 is stretched by a predetermined amount or more, cracks may be formed in the foil. Furthermore, then tension acts on the medium 2 at the time of transferring the foil and the medium 2 is stretched by a predetermined amount or more, wrinkles may be generated in the foil transferred to the medium 2 when the tension of the medium 2 is removed after the foil is transferred. Therefore, the tensile elasticity of the medium 2 is preferably greater than or equal to a predetermined value.

Specifically, the tensile elasticity of the medium 2 is preferably 0.1×10 4 kg/cm2 or more, and more preferably 0.2×10 4 kg/cm2 or more. Thus, the medium 2 of the present form is, for example, made of one synthetic resin selected from among polyvinylidene chloride, high-density polyethylene, medium-density polyethylene, low-density polyethylene, polypropylene, and polyethylene terephthalate. Alternatively, the medium 2 is formed of a synthetic resin obtained by mixing two or more synthetic resins arbitrarily selected from these synthetic resins. Furthermore, the medium 2 may be made of a composite material of fibers and a synthetic resin having a relatively high tensile elasticity. For example, the medium 2 may be formed of tarpaulin or the like.

The foil transfer device 1 includes an adhesive application mechanism 5 (application mechanism), a supporting body 6, a medium conveyance mechanism 7, a transfer roller pair 8 (rollers), a tension application mechanism 10, and a moving direction changing portion 11.

The adhesive application mechanism 5 applies an adhesive to the medium 2. The supporting body 6 supports the adhesive application mechanism 5 from below. The medium conveyance mechanism 7 conveys the medium 2. The transfer roller pair 8 presses the foil transfer sheet 3 onto the medium 2 applied with adhesive to transfer the foil to the medium 2. The tension application mechanism 10 includes a tension bar 9 that comes into contact with the medium 2 applied with the adhesive to apply tension to the medium 2. The moving direction changing portion 11 is a moving direction changing portion 11 that changes the moving direction of the medium 2 in a state of overlapping with the foil transfer sheet 3 after passing through the transfer roller pair 8. The tension bar 9 is disposed between the adhesive application mechanism 5 and the transfer roller pair 8 in the conveyance direction of the medium 2 (feeding direction of the medium 2). The moving direction changing portion 11 is disposed downstream of the transfer roller pair 8 in the conveyance direction of the medium 2.

The foil transfer device 1 includes a first heater 14 and a second heater 15. The first heater 14 heats the medium 2 applied with the adhesive. The second heater 15 heats the medium 2 before the foil is transferred to increase the adhesive force of the adhesive applied to the medium 2 (i.e., the adhesive is activated).

In addition, the foil transfer device 1 includes a medium feeding portion 16, a medium winding portion 17, a sheet feeding portion 18, and a sheet conveying mechanism 19. The medium 2 wound in a roll shape is attached to the medium feeding portion 16, and the medium 2 is fed to the adhesive application mechanism 5. The medium 2 that has passed the transfer roller pair 8 is wound by the medium winding portion 17 and wound into a roll shape. The foil transfer sheet 3 wound into a roll shape is attached to the sheet feeding portion 18, and the foil transfer sheet 3 is fed to the transfer roller pair 8. The sheet conveying mechanism 19 conveys the foil transfer sheet 3 of after the foil is transferred to the medium 2.

As illustrated in FIG. 1, the medium feeding portion 16 is disposed on the back side of the foil transfer device 1, and the medium winding portion 17 is disposed on the front side. The adhesive application mechanism 5 and the transfer roller pair 8 are disposed between the medium feeding portion 16 and the medium winding portion 17 in the front-back direction (X direction). The transfer roller pair 8 is disposed on the front side of the adhesive application mechanism 5.

The adhesive application mechanism 5 is disposed on the upper side of the medium feeding portion 16, the medium winding portion 17, and the transfer roller pair 8.

The transfer roller pair 8 is located on the lower side of the adhesive application mechanism 5 in the vertical direction (Z direction) and is located on the upper side of the medium winding portion 17.

The second heater 15, the tension application mechanism 10, and the first heater 14 are disposed on the upper side of the transfer roller pair 8, and the moving direction changing portion 11 is disposed on the lower side. That is, when viewed from the vertical direction (Z direction), the transfer roller pair 8 is disposed so as to have a portion overlapping the second heater 15, the tension application mechanism 10, the first heater 14, and the moving direction changing portion 11.

The sheet feeding portion 18 is disposed on the upper side of the medium winding portion 17 on the front side of the foil transfer device 1. The sheet feeding portion 18 is located on the upper side of the transfer roller pair 8 in the vertical direction.

The sheet conveying mechanism 19 is located on the lower side of the sheet feeding portion 18 and on the upper side of the medium winding portion 17 in the vertical direction.

The sheet feeding portion 18 is disposed so as to have a portion overlapping the sheet conveying mechanism 19 and the medium winding portion 17 when viewed from the vertical direction.

As described above, in the foil transfer device 1 of the present embodiment, the plurality of components is arranged with their positions shifted in the vertical direction, whereby the components can be arranged close to each other in the front-back direction, and the foil transfer device 1 can be downsized in the front-back direction.

Hereinafter, the configuration of each part of the foil transfer device 1 will be described.

The adhesive application mechanism 5 includes an inkjet head 23 (head portion, hereinafter also simply referred to as “head 23”) that ejects an adhesive onto the medium 2. That is, the adhesive application mechanism 5 applies the adhesive to the medium 2 by an inkjet method. The adhesive application mechanism 5 includes a carriage 24, a carriage driving mechanism 25, a supporting frame 26, and a platen 27. The head portion 23 is mounted on the carriage 24. The carriage driving mechanism 25 moves the carriage 24 in the main scanning direction (Y direction in FIG. 1 etc.), which is the width direction of the medium 2. The supporting frame 26 supports the carriage 24 so as to be movable in the main scanning direction. The platen 27 is disposed on the lower side of the head 23. The carriage driving mechanism 25 includes, for example, a belt partially fixed to the carriage 24, a pulley around which the belt is stretched, and a motor for rotating the pulley.

The head 23 mounted on the carriage 24 ejects the adhesive toward the upper surface of the medium 2 mounted on the platen 27. That is, the head 23 ejects the adhesive downward. A plurality of nozzles for ejecting an adhesive is formed on a lower surface of the head 23. Furthermore, the head 23 includes, for example, a piezoelectric element (piezoelectric element) for ejecting the adhesive from the nozzle. The platen 27 is supported by the supporting body 6 from below. The platen 27 of the present embodiment is a medium mounting portion on which the medium 2 is mounted when the adhesive is applied.

As shown in FIG. 2, one surface of the medium 2 is an adhesive applying surface 2a. Specifically, one surface of the medium 2, which is the upper surface of the medium 2 when mounted on the platen 27, is the adhesive applying surface 2a. The adhesive application mechanism 5 applies the adhesive to a portion of the adhesive applying surface 2a in the width direction (Y direction) of the medium 2. As shown in FIG. 1, the medium 2 is conveyed to the upper surface of the platen 27 from the rear side in the X direction by the medium conveying mechanism 7. The medium 2 to which the adhesive has been applied by the head 23 is carried out from the upper surface of the platen 27 to the front side in the X direction. As a result, the adhesive is applied to the medium 2 along the X direction.

As shown in FIG. 2, an adhesive application region 2c extending in the X direction is formed on the medium 2. The adhesive application mechanism 5 forms a plurality of adhesive application regions 2c at intervals in the width direction (Y direction) of the medium 2. FIG. 2 shows an example in which two adhesive application regions 2c are formed. An adhesive non-application region 2b is formed between the adhesive application regions 2c of the medium 2. That is, on the adhesive applying surface 2a, the adhesive application region 2c to which the adhesive may be applied and the adhesive non-application region 2b to which the adhesive is not applied are alternately formed in the Y direction in the width direction of the medium 2. In this embodiment, for example, a region on both end sides in the width direction of the medium 2 of the adhesive applying surface 2a and a region in the center portion in the width direction of the medium 2 of the adhesive applying surface 2a (region indicated by hatching in FIG. 2) are the adhesive non-application region 2b.

The medium conveying mechanism 7 conveys the long medium 2 along the front-back direction (X direction) of the foil transfer device 1. The medium conveying mechanism 7 includes a conveying roller 30 and a pad roller 31. The pad roller 31 is disposed on the upper side of the conveying roller 30 so as to face the conveying roller 30 and is biased toward the conveying roller 30. The conveying roller 30 and the pad roller 31 are disposed on the upstream side of the platen 27 in the conveyance direction of the medium 2. The conveying roller 30 and the pad roller 31 can be disposed, for example, below the supporting frame 26 behind the platen 27. Although not illustrated, the conveying roller 30 is coupled to a drive mechanism that rotates the conveying roller 30. The medium 2 is conveyed while being sandwiched between the conveying roller 30 and the pad roller 31.

An after-platen 32 is disposed on the front side of the platen 27. A tension application mechanism 10 is disposed below the after-platen 32.

A guide surface 32a is formed on the surface of the after-platen 32. The guide surface 32a is formed in a convex curved surface shape. The guide surface 32a is curved so as to be located on the lower side from the back side toward the front side. The medium 2 carried out from the platen 27 toward the front side comes into contact with the guide surface 32a. A surface of the medium 2 on a side opposite to the adhesive applying surface 2a comes into contact with the guide surface 32a. The medium 2 is guided by the guide surface 32a to the tension bar 9 of the tension application mechanism 10 located on the lower side of the after-platen 32.

The tension application mechanism 10 is disposed below the after-platen 32. The transfer roller pair 8 is disposed below the tension application mechanism 10. That is, the transfer roller pair 8 is disposed below the tension bar 9. The moving direction changing portion 11 is disposed on the lower side of the transfer roller pair 8. Specific configurations of the tension application mechanism 10, the transfer roller pair 8, and the moving direction changing portion 11 will be described later.

The first heater 14 is disposed inside the after-platen 32 so as to lie along the guide surface 32a. The first heater 14 is disposed between the adhesive application mechanism 5 and the tension bar 9 in the conveyance direction of the medium 2. The first heater 14 is disposed on the upper side of the tension bar 9. The first heater 14 heats the medium 2 in contact with the guide surface 32a.

The second heater 15 is disposed between the tension bar 9 and the transfer roller pair 8 in the conveyance direction of the medium 2. The second heater 15 is disposed between the tension bar 9 and the transfer roller pair 8 in the vertical direction. The second heater 15 has a front surface having a convex curved surface shape with respect to the medium 2. The front surface is curved so as to be located on the lower side from the back side toward the front side. A surface of the medium 2 on a side opposite to the adhesive applying surface 2a comes into contact with the front surface of the second heater 15. The medium 2 is heated in contact with the front surface of the second heater 15 and is guided to the transfer roller pair 8 located on the lower side. The adhesive force of the adhesive applied to the medium 2 is increased by heating the medium 2.

The medium feeding portion 16 holds a feeding roll 33 which is the medium 2 wound in a roll shape. The medium feeding portion 16 is attached to the supporting body 6. The medium feeding portion 16 is disposed below the platen 27. Furthermore, the medium feeding portion 16 is disposed below the adhesive application mechanism 5. The medium feeding portion 16 includes a rotating axis inserted to the inner peripheral side of the feeding roll 33.

The medium winding portion 17 holds a winding roll 34 which is the medium 2 wound in a roll shape. The medium winding portion 17 is attached to a supporting frame 35 fixed to the supporting body 6. The supporting frame 35 is disposed on the front side of the supporting body 6. The medium winding portion 17 is disposed below the platen 27. The medium winding portion 17 is disposed on the front side of the after-platen 32, and is disposed on the front side of the adhesive application mechanism 5. The medium winding portion 17 is disposed below the transfer roller pair 8 and on the front side of the transfer roller pair 8.

The medium winding portion 17 includes a rotating axis inserted to the inner peripheral side of the winding roll 34, and a drive mechanism that rotates the rotating axis. The winding roll 34 rotates together with the rotating axis. The medium winding portion 17 further includes a torque limiter for idling the winding roll 34, which torque limiter idles the winding roll 34 so that the tension of the medium 2 wound around the winding roll 34 does not exceed a predetermined tension.

The sheet feeding portion 18 holds a feeding roll 36 which is the foil transfer sheet 3 wound in a roll shape. The sheet feeding portion 18 is attached to the supporting frame 35. The sheet feeding portion 18 is disposed, for example, on the front side of the after-platen 32, and is disposed at substantially the same height as the after-platen 32 in the vertical direction. The sheet feeding portion 18 is disposed on the front side of the transfer roller pair 8 and the tension application mechanism 10.

The sheet feeding portion 18 includes a rotating axis inserted to the inner peripheral side of the feeding roll 36. Furthermore, the sheet feeding portion 18 includes a torque limiter for idling the feeding roll 36. The torque limiter idles the feeding roll 36 such that the foil transfer sheet 3 is fed from the feeding roll 36 when the tension of the foil transfer sheet 3 reaches a predetermined tension.

The sheet conveying mechanism 19 is attached to the supporting frame 35. The sheet conveying mechanism 19 includes a conveying roller 38 and a pad roller 39. The pad roller 39 is disposed to face the conveying roller 38 and is biased toward the conveying roller 38. The conveying roller 38 and the pad roller 39 are disposed on the downstream side of the moving direction changing portion 11 in the conveyance direction of the foil transfer sheet 3. The conveying roller 38 and the pad roller 39 are disposed on the front side of the transfer roller pair 8 and the moving direction changing portion 11.

The conveying roller 38 is coupled to a drive mechanism that rotates the conveying roller 38. The drive mechanism includes a torque limiter for idling the conveying roller 38, and the torque limiter idles the conveying roller 38 so that the tension of the foil transfer sheet 3 conveyed by the sheet conveying mechanism 19 does not exceed a predetermined tension. The foil transfer sheet 3 is conveyed while being sandwiched between the conveying roller 38 and the pad roller 39. The foil transfer sheet 3 conveyed by the sheet conveying mechanism 19 is, for example, wound into a roll shape.

As described above, the medium winding portion 17, the sheet feeding portion 18, and the sheet conveying mechanism 19 are attached to the supporting frame 35. Furthermore, the moving direction changing portion 11 is attached to the supporting frame 35. In the present embodiment, the foil transfer unit 40 is configured by the moving direction changing portion 11, the medium winding portion 17, the sheet feeding portion 18, the sheet conveying mechanism 19, the supporting frame 35, and the like. The supporting frame 35 is fixed to the supporting body 6 with a screw. Therefore, the foil transfer unit 40 is attachable to and detachable from the supporting body 6. That is, the foil transfer unit 40 is detachably attached to the supporting body 6. A wheel 41 is attached to the lower end of the supporting body 6 and the lower end of the supporting frame 35.

### (Configuration of Transfer Roller Pair)

(A) of FIG. 3 is a front view for explaining the configuration of the transfer roller pair 8 shown in FIG. 1, and (B) of FIG. 3 is a side view for explaining the configuration of the transfer roller pair 8 shown in FIG. 1. (A) of FIG. 3 schematically illustrates the foil transfer roller 44 as viewed from the front side (X1 side) of the foil transfer device 1, and the position of the conveying roller 43 is indicated by a virtual line. (B) of FIG. 3 schematically illustrates the configuration of the transfer roller pair 8 as viewed in the left-right direction (Y direction) of the foil transfer device 1.

As illustrated in FIG. 1, the transfer roller pair 8 is disposed below the platen 27 and above the medium winding portion 17. That is, the transfer roller pair 8 is disposed between the platen 27 and the medium winding portion 17 in the vertical direction. The transfer roller pair 8 is disposed on the lower side than the second heater 15. As illustrated in (B) of FIG. 3, the transfer roller pair 8 includes a conveying roller 43 and a foil transfer roller 44 (a pair of rollers). The conveying roller 43 contacts into contact with the medium 2 to convey the medium 2 toward the lower side. The foil transfer roller 44 sandwiches the medium 2 and the foil transfer sheet 3 between itself and the conveying roller 43.

The conveying roller 43 and the foil transfer roller 44 are provided to be rotatable about a rotation axis extending in the width direction of the medium 2, that is, along the Y direction. The foil transfer roller 44 faces the conveying roller 43 from the front side. That is, the conveying roller 43 and the foil transfer roller 44 face each other in the X direction (front-back direction). Furthermore, the foil transfer roller 44 is biased toward the conveying roller 43. The conveying roller 43 is coupled to a drive mechanism (not illustrated) that rotates the conveying roller 43. The foil transfer roller 44 rotates following the rotation of the conveying roller 43.

The medium 2 and the foil transfer sheet 3 merge at the transfer roller pair 8, and are in close contact with each other between the conveying roller 43 and the foil transfer roller 44. Specifically, the surface of the foil transfer sheet 3 on which the foil is formed and the adhesive applying surface 2a of the medium 2 are in close contact with each other between the conveying roller 43 and the foil transfer roller 44. The foil transfer sheet 3 is disposed on the front side and the medium 2 is disposed on the back side between the conveying roller 43 and the foil transfer roller 44. The foil transfer roller 44 is in contact with the foil transfer sheet 3 from the front side, and the conveying roller 43 is in contact with the medium 2 from the back side. A guide roller 45 for guiding the foil transfer sheet 3 fed from the sheet feeding portion 18 to the transfer roller pair 8 is disposed above the foil transfer roller 44.

The foil is transferred from the foil transfer sheet 3 to the medium 2 between the conveying roller 43 and the foil transfer roller 44. Specifically, the foil is transferred from the foil transfer sheet 3 to a portion of the medium 2 where the adhesive is applied. The medium 2 is heated by the second heater 15 before reaching the transfer roller pair 8. The medium 2 and the foil transfer sheet 3 are conveyed by the transfer roller pair 8 while being sandwiched between the conveying roller 43 and the foil transfer roller 44. Specifically, the medium 2 and the foil transfer sheet 3 are conveyed toward the lower side while being sandwiched between the conveying roller 43 and the foil transfer roller 44.

As shown in (A) of FIG. 3, the foil transfer roller 44 can be divided in the left-right direction (i.e., the axial direction of the foil transfer roller 44), and can be configured by a plurality of divided rollers 46. The foil transfer roller 44 of the present embodiment includes, for example, two divided rollers 46 as illustrated in (A) of FIG. 3. The divided roller 46 is, for example, a rubber roller made of rubber. The two divided rollers 46 are disposed adjacent to each other in the left-right direction.

Both end sides of the two divided rollers 46 are rotatably supported by the bearing 47. Specifically, the divided roller 46 is fixed to a rotating axis 48 whose axial direction is the left-right direction, and both end portions of the rotating axis 48 are rotatably supported by the bearing 47. The length of each of the divided rollers 46 in the left-right direction is set in accordance with the length of the adhesive application region 2c (see FIG. 2) of the medium 2 in the left-right direction. The divided roller 46 is disposed at a position through which the adhesive application region 2c of the medium 2 passes. The bearing 47 is disposed at a position through which the adhesive non-application region 2b of the medium 2 passes in the left-right direction.

The intermediate portion of each of the divided rollers 46 is rotatably supported by an intermediate supporting member 49. The intermediate supporting member 49 supports the divided roller 46 from the front side. That is, the intermediate supporting member 49 supports the divided roller 46 on the opposite side of the conveying roller 43. The intermediate supporting member 49 supports the divided roller 46 at the center position in the left-right direction. The intermediate supporting member 49 includes a driven roller 50 that rotates following the rotation of the divided roller 46.

As described above, the foil transfer roller 44 is biased toward the conveying roller 43. Specifically, the bearing 47 and the intermediate supporting member 49 are attached to a frame (not illustrated), and the frame is biased toward the conveying roller 43. Note that, the conveying roller 43 includes one roller. The conveying roller 43 is made of stainless steel, for example. The surface (outer peripheral surface) of the conveying roller 43 is a smooth surface.

### (Configuration of Tension Application Mechanism)

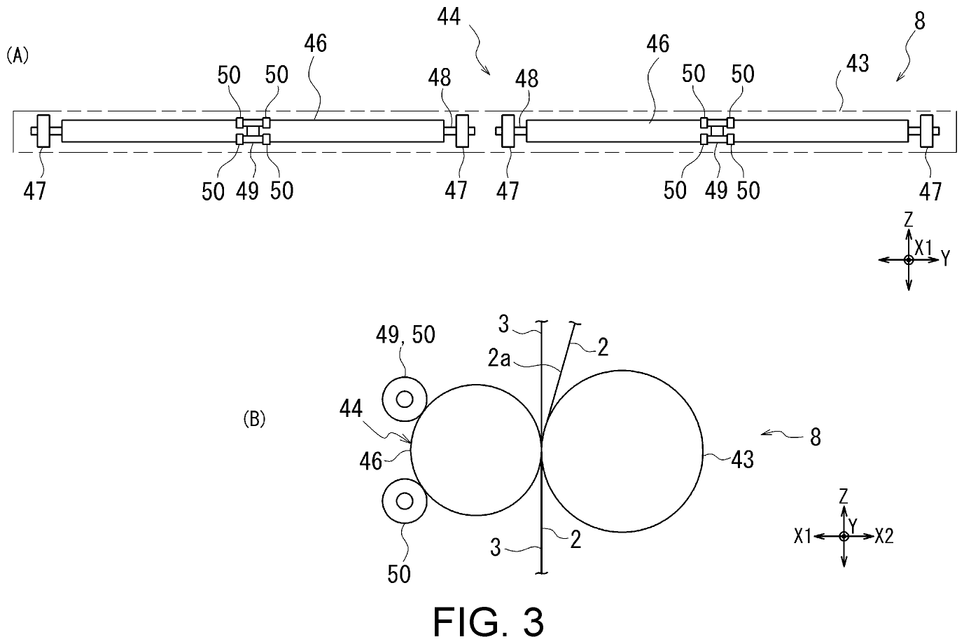

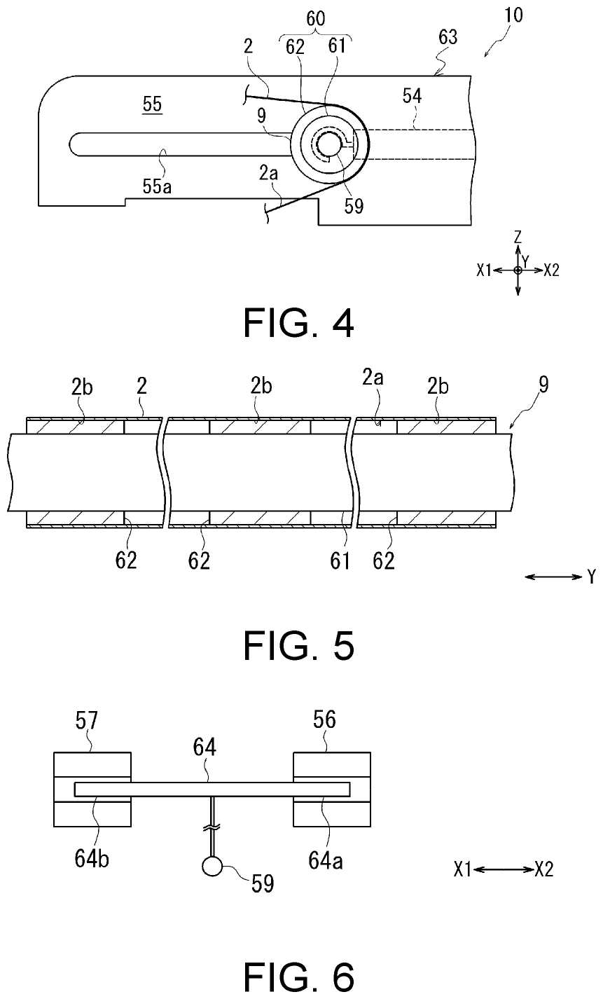

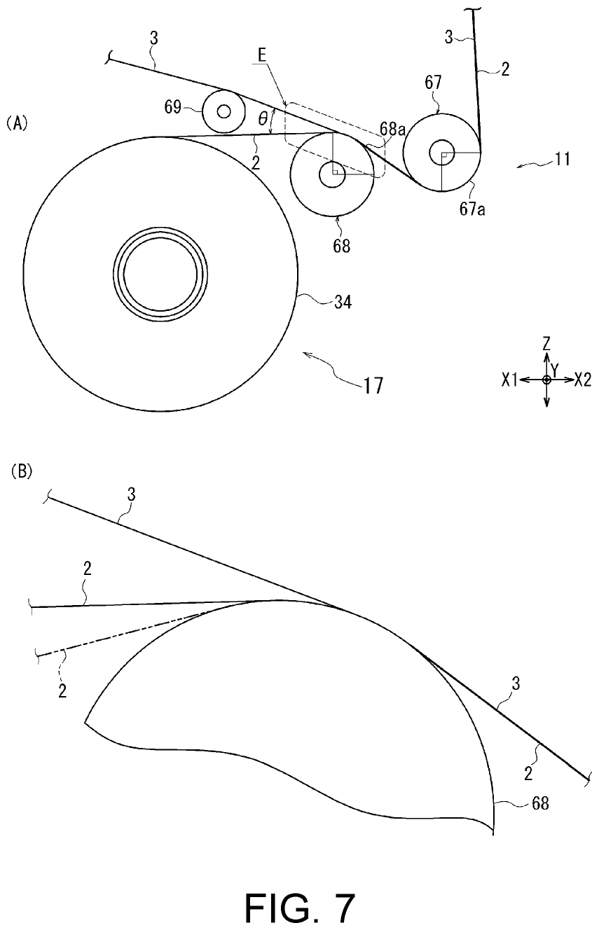

FIG. 4 is a side view for explaining the configuration of the tension application mechanism 10 shown in FIG. 1. FIG. 5 is a cross-sectional view for explaining the configuration of the tension bar 9 shown in FIG. 4. FIG. 6 is a diagram for explaining the sensors 56 and 57 that detect the position of the tension bar 9 illustrated in FIG. 4.

As described above, the tension application mechanism 10 includes the tension bar 9. The tension application mechanism 10 includes, in addition to the tension bar 9, a tension coil spring 54 that biases the tension bar 9 in a direction (back side) of pressing the tension bar 9 against the medium 2, and a bar holding portion 55 that movably holds the tension bar 9. The tension application mechanism 10 includes two sensors 56 and 57 for detecting the position of the tension bar 9. Although not illustrated, the detection results of the sensors 56 and 57 are input to a control device that controls a drive mechanism for rotating the conveying roller 43. The control device rotates or stops the conveying roller 43 according to the detection results of the sensors 56 and 57.

The tension bar 9 is disposed between the adhesive application mechanism 5 and the transfer roller pair 8, and applies tension to the medium 2 to which the adhesive has been applied and to which the foil has not yet been transferred. Furthermore, the tension bar 9 is disposed between the platen 27 and the transfer roller pair 8, and between the first heater 14 and the second heater 15 in the vertical direction. The tension bar 9 is disposed on the back side than the front surface of the second heater 15 in contact with the medium 2 and is disposed on the back side than the lower end of the guide surface 32a of the after-platen 32. The medium 2 guided to the upper side of the tension bar 9 by the guide surface 32a goes around to the back side of the tension bar 9 from the front side and is wrapped around the tension bar 9, returned to the front side again at the lower side of the tension bar 9, and comes into contact with the front surface of the second heater 15. The tension bar 9 comes into contact with the front surface side of the medium 2, that is, the adhesive applying surface 2a.

As described above, since the tension bar 9 is biased toward the back side by the tension coil spring 54, the medium 2 is pulled toward the back side by being wound around the tension bar 9, and tension is applied thereto.

The tension bar 9 includes a support shaft 59 formed in an elongated columnar shape, and a roller 60 rotatably held by the support shaft 59. The support shaft 59 is disposed along the axial direction of the support shaft 59 and the left-right direction (Y direction). The roller 60 includes a roller main body 61 formed in a cylindrical shape elongated in the left-right direction, and a cylindrical contact portion 62 fixed to the outer peripheral surface of the roller main body 61. The length of the contact portion 62 in the left-right direction is set in accordance with the length of the adhesive non-application region 2b formed on the medium 2 in the left-right direction, and is arranged in accordance with the position where the adhesive non-application region 2b is formed, and is provided at an interval in the left-right direction. The roller 60 of the present embodiment includes, for example, one roller main body portion 61 and three contact portions 62.

The length (length in the left-right direction) of the roller main body 61 is shorter than the length (length in the left-right direction) of the support shaft 59. The length (length in the left-right direction) of the contact portion 62 is shorter than the length (length in the left-right direction) of the roller main body 61. The support shaft 59 is inserted to the inner peripheral side of the roller main body 61, and the roller 60 is rotatable with respect to the support shaft 59 with the left-right direction as an axial direction of rotation. Both end portions of the support shaft 59 respectively protrude outward in the left-right direction from both ends of the roller main body 61.

The contact portion 62 is a spacer formed in a cylindrical shape. The contact portion 62 is fixed to three positions of both end portions in the left-right direction and a center portion in the left-right direction of the roller main body 61. Furthermore, the contact portion 62 is fixed to the roller main body 61 such that the axial center of the contact portion 62 coincides with the axial center of the roller main body 61. That is, the contact portion 62 bulges out in the outer diameter direction with respect to the roller main body 61. The outer diameter of the portion of the roller 60 where the contact portion 62 is disposed is larger than the outer diameter of the other portion of the roller 60. As a result, when the medium 2 is wound around the tension bar 9, only the contact portion 62 comes into contact with the medium 2. As described above, since the contact portion 62 is disposed in accordance with the position where the adhesive non-application region 2b is formed, the contact portion 62 does not contact the adhesive application region 2c but contacts only the adhesive non-application region 2b. The roller main body 61 of the present embodiment in which the tension bar 9 can apply tension to the medium 2 without interfering with the adhesive applied to the medium 2 is a bar main body that holds the contact portion 62.

The bar holding portion 55 supports each of both end portions of the support shaft 59. The bar holding portion 55 is formed on the supporting member 63 disposed on both sides of the roller 60 in the left-right direction. A back end portion of the supporting member 63 is fixed to the supporting body 6. A guide groove 55a through which the end portion of the support shaft 59 is inserted is formed in the bar holding portion 55. The guide groove 55a is formed in a linear shape (slit shape) having the longitudinal direction as the front-back direction. The support shaft 59 is movable in the front-back direction along the guide groove 55a. That is, the tension bar 9 is movable in the front-back direction with respect to the bar holding portion 55.

The tension coil spring 54 is disposed on both sides of the roller 60 in the left-right direction. One end portion of the tension coil spring 54 is engaged with the end portion of the support shaft 59, and the other end portion of the tension coil spring 54 is engaged with the supporting member 63. The tension coil spring 54 biases the tension bar 9 toward the back side.

As illustrated in FIG. 6, each of the sensors 56 and 57 is a transmissive optical sensor including a light emitting portion and a light receiving portion, where the light emitting portion and the light receiving portion are, for example, arranged to face each other in a state of being spaced apart from each other in a vertical direction. Although not illustrated in FIG. 4, the sensors 56 and 57 are attached to the supporting member 63. As illustrated in FIG. 6, the sensor 56 and the sensor 57 are disposed in a state of being spaced apart from each other in the front-back direction. The sensor 56 is disposed on the back side of the sensor 57, and functions to detect the position of the tension bar 9 at the back side. The sensor 57 also functions to detect the position of the tension bar 9 on the front side. The support shaft 59 of the tension bar 9 is fixed to the light shielding member 64 via a predetermined member.

The light shielding member 64 is formed with a light shielding portion 64a capable of shielding between the light emitting portion and the light receiving portion of the sensor 56, and a light shielding portion 64b capable of shielding between the light emitting portion and the light receiving portion of the sensor 57. In the present embodiment, when the tension bar 9 is disposed at a position where the light shielding portion 64a shields between the light emitting portion and the light receiving portion of the sensor 56, and the light shielding portion 64b shields between the light emitting portion and the light receiving portion of the sensor 57, the conveying roller 43 is in an activatable state, and the medium 2 and the foil transfer sheet 3 can be conveyed by the transfer roller pair 8.

Furthermore, in the present embodiment, when the tension bar 9 is moved to a position where the light shielding portion 64a is removed from between the light emitting portion and the light receiving portion of the sensor 56 or the light shielding portion 64b is removed from between the light emitting portion and the light receiving portion of the sensor 57 during the driving of the conveying roller 43, the control device that controls the driving mechanism of the conveying roller 43 stops the rotation of the conveying roller 43. The conveyance of the medium 2 is stopped by stopping the rotation of the conveying roller 43. That is, the medium 2 is conveyed only when the tension bar 9 is located at a position within the predetermined range, so that variation in the tension applied to the medium 2 from the tension bar 9 can be reduced. In the present embodiment, even if the tension bar 9 moves in the front-back direction by a predetermined range, a state in which the light shielding portion 64a shields between the light emitting portion and the light receiving portion of the sensor 56 and the light shielding portion 64b shields between the light emitting portion and the light receiving portion of the sensor 57 is maintained.

### (Configuration of Moving Direction Changing Portion)

(A) of FIG. 7 is a side view for explaining a configuration of a moving direction changing portion 11 shown in FIG. 1, and (B) of FIG. 7 is an enlarged view of portion E in (A) of FIG. 7.

As illustrated in (A) of FIG. 7, the moving direction changing portion 11 includes a first changing roller 67, a second changing roller 68, and a guide roller 69. The first changing roller 67 bends the medium 2 after passing through the transfer roller pair 8 in a predetermined direction. The first changing roller 67 and the second changing roller 68 for guiding the medium 2 after passing through the first changing roller 67 in a predetermined direction are provided. The first changing roller 67 and the second changing roller 68 are rotatably supported by the supporting frame 35. The first changing roller 67 and the second changing roller 68 are rotatable with respect to the supporting frame 35 with the left-right direction as an axial direction of rotation.

The first changing roller 67 is disposed on the lower side of the foil transfer roller 44. The first changing roller 67 is disposed at a position adjacent in the front-back direction to the medium 2 and the foil transfer sheet 3 that pass through the foil transfer roller 44 and move toward the lower side, and is disposed at a position that comes into contact with the medium 2 and the foil transfer sheet 3 from the front side. The second changing roller 68 is disposed on the front side of the first changing roller 67. The second changing roller 68 is disposed slightly on the lower side than the first changing roller 67. However, the upper end of the second changing roller 68 is disposed on the upper side of the lower end of the first changing roller 67.

An axial center of the winding roll 34 of the medium winding portion 17 is disposed on the obliquely front lower side of the second changing roller 68. The guide roller 69 is disposed on the obliquely front upper side of the second changing roller 68. The conveying roller 38 and the pad roller 39 of the sheet conveying mechanism 19 are further disposed on the obliquely front upper side of the guide roller 69. The conveying roller 38 and the pad roller 39 are disposed on the obliquely front upper side of the axial center of the winding roll 34.

The medium 2 that has passed through the transfer roller pair 8 moves toward the lower side while overlapping the foil transfer sheet 3. The first changing roller 67 bends the medium 2 overlapping the foil transfer sheet 3 toward the front side. The second changing roller 68 has a function of guiding the medium 2, which has passed through the first changing roller 67 and is overlapped with the foil transfer sheet 3, toward the obliquely front upper side. The medium 2 in a state of overlapping with the foil transfer sheet 3 passes the upper side of the second changing roller 68. The medium 2 in a state of overlapping with the foil transfer sheet 3 is in contact with the outer peripheral surface of the second changing roller 68.

The first changing roller 67 and the second changing roller 68 of the present embodiment are moving direction changing rollers for changing the moving direction of the medium 2 in a state of overlapping with the foil transfer sheet 3 after passing through the transfer roller pair 8. The first changing roller 67 and the second changing roller 68 change the moving direction of the medium 2 moving toward the lower side from the transfer roller pair 8 to the first changing roller 67 in a state of overlapping with the foil transfer sheet 3 to the obliquely front upper side. That is, the first changing roller 67 and the second changing roller 68 change the moving direction of the medium 2 in a state of overlapping with the foil transfer sheet 3 to a direction different from the moving direction of the medium 2 from the transfer roller pair 8 to the first changing roller 67 (i.e., the moving direction of the medium 2 from the transfer roller pair 8 to the moving direction changing roller).

Specifically, as shown in (A) of FIG. 7, after passing through the transfer roller pair 8, the medium 2 and the foil transfer sheet 3 move toward the lower side in an overlapping state, and come into contact with the outer peripheral surface of the first changing roller 67 adjacently arranged on the front side. The medium 2 and the foil transfer sheet 3 are changed in direction by being guided by the arcuate surface 67a of the first changing roller 67.

The arcuate surface 67a is an arcuate surface formed between a position on the back side of the first changing roller 67 where a tangent line parallel to the vertical direction passes and a position on the lower side of the first changing roller 67 where a tangent line parallel to the front-back direction passes. The arcuate surface 67a has a central angle of 90°, and is curved so as to be located on the front side as it goes toward the lower side. The moving direction of the medium 2 and the foil transfer sheet 3 is rotated by about 90° about the axial center of the first changing roller 67 by being guided by the arcuate surface 67a. Specifically, the moving direction of the medium 2 is changed from a direction toward the lower side to a direction toward a front side. The medium 2 and the foil transfer sheet 3 whose moving direction has been changed are conveyed in a state where the medium 2 is located on the lower side of the foil transfer sheet 3.

When the medium 2 and the foil transfer sheet 3 pass through the arcuate surface 67a, the medium 2 and the foil transfer sheet 3 move to the obliquely upper side, are separated from the outer peripheral surface of the first changing roller 67 and guided by the second changing roller 68, and come into contact with the arcuate surface 68a.

The arcuate surface 68a is an arcuate surface formed between a position on the back side of the second changing roller 68 where a tangent line parallel to the vertical direction passes and a position on the upper side of the second changing roller 68 where a tangent line parallel to the front-back direction passes. The arcuate surface 68a has a central angle of 90°, and is curved so as to be located on the upper side as it goes toward the front side.

The medium 2 and the foil transfer sheet 3 move to the upper side of the second changing roller 68 by being guided on the arcuate surface 68a.

As illustrated in (B) of FIG. 7, the foil transfer sheet 3 moved to the upper side is separated from the arcuate surface 68a and guided to the guide roller 69 located on the upper side.

On the other hand, since the medium 2 located on the lower side of the foil transfer sheet 3 further moves along the arcuate surface 68a, the medium 2 is separated from the foil transfer sheet 3 at the vicinity of the terminal end of the arcuate surface 68a. After passing through the arcuate surface 68a, the medium 2 is separated from the second changing roller 68 and guided to the winding roll 34 located on the lower side.

The first changing roller 67 has an outer diameter (diameter) of greater than or equal to two inches. In the present embodiment, the outer diameter of the first changing roller 67 is greater than or equal to 3 inches. Specifically, the outer diameter of the first changing roller 67 is 3 inches. The outer diameter of the second changing roller 68 is equal to the outer diameter of the first changing roller 67. Note that, the outer diameter of the first changing roller 67 and the outer diameter of the second changing roller 68 may be different from each other.

The medium 2 separated from the foil transfer sheet 3 by the second changing roller 68 is conveyed toward the front side and wound around the winding roll 34. The foil transfer sheet 3 separated from the medium 2 is guided to the obliquely front upper side by a guide roller 69 and conveyed by a sheet conveying mechanism 19. The moving direction changing portion 11 includes a guide roller 69 for guiding the foil transfer sheet 3 that has passed through the second changing roller 68 and separated from the medium 2 in a predetermined direction.

The guide roller 69 is rotatably supported by the supporting frame 35. The guide roller 69 is rotatable with respect to the supporting frame 35 with the left-right direction as an axial direction of rotation. The guide roller 69 is disposed on the obliquely front upper side of the second changing roller 68. The guide roller 69 is disposed on the obliquely back upper side of the axial center of the winding roll 34. The foil transfer sheet 3 separated from the medium 2 passes the upper side of the guide roller 69. The foil transfer sheet 3 separated from the medium 2 is guided to the obliquely front upper side from the second changing roller 68 by the guide roller 69.

As described above, the medium 2 overlapping with the foil transfer sheet 3 is in contact with the outer peripheral surface of the second changing roller 68, and the medium 2 and the foil transfer sheet 3 are separated from each other at a position where the foil transfer sheet 3 is separated from the second changing roller 68 (near the terminating end of the arcuate surface 68a). The position where the foil transfer sheet 3 is separated can be appropriately adjusted by, for example, setting of the position and the outer diameter of the guide roller 69. In the present embodiment, the medium 2 and the foil transfer sheet 3 are separated at a certain position. Furthermore, since the medium 2 after being separated from the foil transfer sheet 3 moves slightly along the outer peripheral surface of the second changing roller 68 and then separates from the second changing roller 68, when viewed from the left-right direction, the angle formed by the medium 2 and the foil transfer sheet 3 when the medium 2 and the foil transfer sheet 3 are separated is constant.

The medium 2 separated from the foil transfer sheet 3 is moving toward the winding roll 34, and linearly extends in the forward direction from the second changing roller 68 when viewed from the left-right direction. The foil transfer sheet 3 separated from the medium 2 is moving toward the guide roller 69, and linearly extends in the obliquely forward direction from the second changing roller 68 when viewed from the left-right direction. In the present embodiment, when viewed from the left-right direction, an angle θ (see (A) of FIG. 7) formed by the medium 2 separated by passing through the second changing roller 68 and the foil transfer sheet 3 is an acute angle. That is, the angle θ formed by the medium 2 linearly extending in the forward direction from the second changing roller 68 and the foil transfer sheet 3 linearly extending in the obliquely forward direction from the second changing roller 68 is an acute angle. Specifically, the angle θ is less than or equal to 60°. In the present embodiment, the angle θ is less than or equal to 45°.

The position where the medium 2 separated from the foil transfer sheet 3 is separated from the second changing roller 68 varies depending on the outer diameter of the winding roll 34. For example, when the outer diameter of the winding roll 34 is relatively large, the medium 2 is separated from the second changing roller 68 at the position indicated by the solid line in (B) of FIG. 7. On the other hand, when the outer diameter of the winding roll 34 decreases, the medium 2 is separated from the second changing roller 68 at a position indicated by a two-dot chain line in (B) of FIG. 7. The angle θ varies depending on the outer diameter of the winding roll 34. When the position of the guide roller 69 is adjustable, the angle θ can be adjusted by adjusting the position of the guide roller 69.

### (Main Effect of Present Embodiment)

As described above, the foil transfer device 1 of the present embodiment has the following configuration.

(1) The foil transfer device 1 includes an adhesive application mechanism 5 (application mechanism) and a transfer roller pair 8 (roller).

The adhesive application mechanism 5 applies an adhesive to the medium 2.

The transfer roller pair 8 presses the foil transfer sheet 3 (sheet) in which the foil is formed on the base material against the medium 2 to which the adhesive is applied to transfer the foil to the medium 2.

The adhesive application mechanism 5 includes an inkjet head 23 (head portion) that ejects an adhesive onto the medium 2, and a platen 27 (medium mounting portion) that is disposed on the lower side of the inkjet head 23 and on which the medium 2 is mounted.

The transfer roller pair 8 is disposed on the lower side of the platen 27.

That is, in the present embodiment, the position of the medium 2 when the adhesive is applied and the position of the medium 2 when the foil is transferred are shifted in the vertical direction. In other words, the region for applying the adhesive to the medium 2 and the region for transferring the foil to the medium 2 are shifted in the vertical direction. Thus, in the present embodiment, it is possible to bring the two regions close to each other in the front-back direction (X direction) while preventing the region for applying the adhesive to the medium 2 and the region for transferring the foil to the medium 2 from interfering with each other.

Therefore, in the present embodiment, the foil transfer device 1 can be downsized in the front-back direction, and as a result, the installation area of the foil transfer device 1 can be reduced.

(2) The transfer roller pair 8 includes a pair of rollers (a conveying roller 43 and a foil transfer roller 44) sandwiching the medium 2 and the foil transfer sheet 3. The conveying roller 43 and the foil transfer roller 44 are arranged to face each other in the front-back direction (direction orthogonal to the vertical direction) of the foil transfer device 1.

By arranging the conveying roller 43 and the foil transfer roller 44 on the lower side of the platen 27 so as to face each other in the front-back direction, the medium 2 conveyed in the downward direction from the platen 27 can be overlapped on the foil transfer sheet 3 without changing the direction, which can contribute to reducing the size of the foil transfer device 1.

(3) The foil transfer device 1 includes a medium feeding portion 16 that feeds the medium 2 to the adhesive application mechanism 5 and a medium winding portion 17 that winds the medium 2 that has passed through the transfer roller pair 8. The medium feeding portion 16 and the medium winding portion 17 are disposed, for example, on the lower side of the adhesive application mechanism 5.

As a result, the foil transfer device 1 can be further downsized in the front-back direction, and as a result, the installation area of the foil transfer device 1 can be further reduced.

One of the medium feeding portion 16 and the medium winding portion 17 may be disposed on the lower side of the adhesive application mechanism 5.

(4) The foil transfer device 1 includes a tension application mechanism 10 having a tension bar 9 that comes into contact with the medium 2 applied with the adhesive to apply tension to the medium 2. The tension bar 9 is disposed between the platen 27 and the transfer roller pair 8 in the vertical direction.

Accordingly, even when the foil transfer device 1 includes the tension bar 9, the foil transfer device 1 can be downsized in the front-back direction.

(5) The foil transfer device 1 includes a first heater 14 and a second heater 15 that heat the medium 2.

The first heater 14 is disposed on the upper side of the tension bar 9. The second heater 15 is disposed between the tension bar 9 and the transfer roller pair 8 in the vertical direction.

Accordingly, even when the foil transfer device 1 includes the first heater 14 and the second heater 15, the foil transfer device 1 can be downsized in the front-back direction.

In the present embodiment, sensors 56 and 57 that detect the position of the tension bar 9 are provided. When the position of the tension bar 9 detected by the sensors 56 and 57 is within the predetermined range, the conveying roller 43 of the transfer roller pair 8 conveys the medium 2. Specifically, when the tension bar 9 is disposed at a position where the light shielding portion 64a shields between the light emitting portion and the light receiving portion of the sensor 56 and the light shielding portion 64b shields between the light emitting portion and the light receiving portion of the sensor 57, the medium 2 and the foil transfer sheet 3 can be conveyed by the transfer roller pair 8, and the foil can be transferred to the medium 2. In this embodiment, therefore, the tension bar 9 suppresses variations in the tension of the medium 2 when the foil is transferred.

Therefore, in the present embodiment, it is possible to suppress the foil from being transferred to the medium 2 in a slack state or the foil from being transferred to the medium 2 in a state where a large tension is applied. Thus, in the present embodiment, for example, the foil is transferred to the medium 2 in a slack state, and as a result, it is possible to suppress the occurrence of cracks in the foil when the slack of the medium 2 after the foil is transferred is removed. Furthermore, in the present embodiment, for example, the foil is transferred to the medium 2 in a state where a large tension is applied, and as a result, it is possible to suppress generation of wrinkles in the foil when the tension of the medium 2 after the foil is transferred is relaxed. That is, in the present embodiment, the occurrence of cracks and wrinkles in the foil transferred to the medium 2 can be suppressed.

In the present embodiment, the second heater 15 for heating the medium 2 before the foil is transferred to increase the adhesive force of the adhesive applied to the medium 2 is disposed between the tension bar 9 and the transfer roller pair 8 in the conveyance direction of the medium 2. Therefore, in the present embodiment, even if the tension bar 9 is disposed between the first heater 14 and the transfer roller pair 8, the adhesive force of the adhesive applied to the medium 2 when reaching the transfer roller pair 8 can be increased by the second heater 15. Therefore, in the present embodiment, the foil can be appropriately transferred to the portion of the medium 2 to which the adhesive is applied by the transfer roller pair 8.

(6) The foil transfer device 1 includes a sheet feeding portion 18 that feeds the foil transfer sheet 3 to the transfer roller pair 8, and a supporting body 6 that supports the platen 27 from below. The sheet feeding portion 18 is detachably attached to the supporting body 6.

Thus, for example, the foil transfer device 1 can be used as an inkjet printer by detaching the foil transfer unit 40 including the sheet feeding portion 18 from the supporting body 6 and ejecting ink from the head 23. Therefore, in the present embodiment, versatility of the foil transfer device 1 can be enhanced. Note that, when the foil transfer device 1 is used as an inkjet printer, for example, the medium winding portion 17 is attached to the supporting body 6.

(7) In the foil transfer device 1, the transfer roller pair 8 includes a conveying roller 43 that comes into contact with the medium 2 and conveys the medium 2, and a foil transfer roller 44 (transfer roller) that is biased toward the conveying roller 43 and sandwiches the medium 2 and the foil transfer sheet 3 between itself and the conveying roller 43. The foil transfer roller 44 includes two (a plurality of) divided rollers 46 divided in the left-right direction (Y direction) along the axial direction of the foil transfer roller 44. Both end sides of the two divided rollers 46 are rotatably supported by the bearing 47.

Thus, in the present embodiment, even if the width of the medium 2 is wide, the deflection of the foil transfer roller 44 when the medium 2 and the foil transfer sheet 3 are pressed against the conveying roller 43 can be suppressed. Therefore, in the present embodiment, even if the width of the medium 2 is wide, the foil can be appropriately transferred to the portion of the medium 2 to where the adhesive is applied by the transfer roller pair 8.

(8) In the foil transfer device 1, an intermediate portion of the divided roller 46 is rotatably supported by an intermediate supporting member 49.

Thus, even if the width of the medium 2 is wide, the deflection of the foil transfer roller 44 when the medium 2 and the foil transfer sheet 3 are pressed against the conveying roller 43 can be effectively suppressed. Therefore, in the present embodiment, even if the width of the medium 2 is wide, the foil can be appropriately transferred to the portion of the medium 2 to where the adhesive is applied by the transfer roller pair 8.

(9, 10) The foil transfer device 1 includes an adhesive application mechanism 5 (application mechanism), a transfer roller pair 8 (rollers), and a tension application mechanism 10.

The adhesive application mechanism 5 applies an adhesive to the medium 2.

The transfer roller pair 8 presses the foil transfer sheet 3 (sheet) in which the foil is formed on the base material against the medium 2 to which the adhesive is applied to transfer the foil to the medium 2.

The tension application mechanism 10 includes a tension bar 9 that comes into contact with the medium 2 to apply tension to the medium 2.

The tension bar 9 is disposed between the adhesive application mechanism 5 and the transfer roller pair 8.

The adhesive application mechanism 5 includes an inkjet head 23 (head portion) that ejects adhesive onto the medium 2.

By disposing the tension bar 9 between the adhesive application mechanism 5 and the transfer roller pair 8, the foil transfer device 1 can be downsized in the front-back direction (X direction).

Specifically, when the tension bar 9 is disposed at a position where the light shielding portion 64a shields between the light emitting portion and the light receiving portion of the sensor 56 and the light shielding portion 64b shields between the light emitting portion and the light receiving portion of the sensor 57, the medium 2 and the foil transfer sheet 3 can be conveyed by the transfer roller pair 8, and the foil can be transferred to the medium 2.

In this embodiment, therefore, the tension bar 9 suppresses variations in the tension of the medium 2 when the foil is transferred. Therefore, in the present embodiment, it is possible to suppress the foil from being transferred to the medium 2 in a slack state or the foil from being transferred to the medium 2 in a state where a large tension is applied. Thus, in the present embodiment, for example, the foil is transferred to the medium 2 in a slack state, and as a result, it is possible to suppress the occurrence of cracks in the foil when the slack of the medium 2 after the foil is transferred is removed. Furthermore, in the present embodiment, for example, the foil is transferred to the medium 2 in a state where a large tension is applied, and as a result, it is possible to suppress generation of wrinkles in the foil when the tension of the medium 2 after the foil is transferred is relaxed. That is, in the present embodiment, the occurrence of cracks and wrinkles in the foil transferred to the medium 2 can be suppressed.

(11) In the foil transfer device 1, the adhesive application mechanism 5 applies adhesive to a part of the adhesive applying surface 2a, which is one surface of the medium 2, in the width direction of the medium 2.

An adhesive non-application region 2b (non-application region) to which the adhesive is not applied in the width direction of the medium 2 is formed on the adhesive applying surface 2a.

The tension bar 9 includes a contact portion 62 that comes into contact with the adhesive non-application region 2b of the adhesive applying surface 2a of the medium 2, and a roller main body 61 (bar main body) that holds the contact portion 62. In the tension bar 9, only the contact portion 62 is in contact with the medium 2.

Therefore, even if the tension bar 9 is in contact with the adhesive-applying surface 2a of the medium 2, the adhesive applied to the medium 2 can be prevented from attaching to the tension bar 9.

(12) The medium 2 before the adhesive is applied and the medium 2 after the foil is transferred are wound in a roll shape, and the foil transfer sheet 3 before the foil is transferred to the medium 2 is wound in a roll shape.

As described above, the medium 2 and the foil transfer sheet 3 are wound in a roll shape in the medium feeding portion 16, the medium winding portion 17, and the sheet feeding portion 18, whereby the foil transfer device 1 can be downsized.

(13) The foil transfer device 1 includes a first changing roller 67 and a second changing roller 68 (direction changing roller). The first changing roller 67 and the second changing roller 68 change the moving direction of the medium 2 in a state of overlapping with the foil transfer sheet 3 after passing through the transfer roller pair 8. The first changing roller 67 and the second changing roller 68 change the moving direction of the medium 2 to a direction different from the moving direction of the medium 2 from the transfer roller pair 8 to the first changing roller 67.

As a result, the foil transfer device 1 can be downsized in the moving direction of the medium 2 immediately after passing through the transfer roller pair 8 as compared with the case where the first changing roller 67 and the second changing roller 68 are not provided. For example, in the present embodiment, the foil transfer device 1 can be downsized in the vertical direction by changing the moving direction of the medium 2 from the vertical direction to the front-back direction after passing through the transfer roller pair 8.

(14) In the foil transfer device 1, the medium 2 and the foil transfer sheet 3 are separated when passing through the second changing roller 68.

That is, the medium 2 and the foil transfer sheet 3 overlap each other between the transfer roller pair 8 and the second changing roller 68 in the conveyance direction of the medium 2. Therefore, in the present embodiment, a space for moving the medium 2 and the foil transfer sheet 3 can be reduced between the transfer roller pair 8 and the second changing roller 68 in the conveyance direction of the medium 2.

(15) The foil transfer device 1 includes an adhesive application mechanism 5 (application mechanism), a transfer roller pair 8 (roller), and a first changing roller 67 and a second changing roller 68 (direction changing roller).

The adhesive application mechanism 5 (application mechanism) applies an adhesive to the medium 2.

The transfer roller pair 8 presses the foil transfer sheet 3 in which the foil is formed on the base material against the medium 2 applied with the adhesive to transfer the foil to the medium 2.

The first changing roller 67 and the second changing roller 68 change the moving direction of the medium 2 in a state of overlapping with the foil transfer sheet 3 after passing through the transfer roller pair 8.

Thus, in the present embodiment, the foil transfer device 1 can be downsized, and the area required for installation can be reduced.

For example, the first changing roller 67 and the second changing roller 68 change the moving direction of the medium 2 moving toward the lower side from the transfer roller pair 8 to the first changing roller 67 in a state of overlapping with the foil transfer sheet 3 to the obliquely front upper side. That is, in the present embodiment, the first changing roller 67 and the second changing roller 68 change the moving direction of the medium 2 in a state of overlapping the foil transfer sheet 3 to a direction different from the moving direction of the medium 2 from the transfer roller pair 8 to the first changing roller 67.

Therefore, in the present embodiment, as compared with the case where the first changing roller 67 and the second changing roller 68 are not provided, the foil transfer device 1 can be suppressed from enlarging in the moving direction of the medium 2 immediately after passing through the transfer roller pair 8. That is, in the present embodiment, the foil transfer device 1 can be downsized in the vertical direction.

(16, 17, 18) The foil transfer device 1 includes, as the direction changing roller, a first changing roller 67 that bends the medium 2 in a predetermined direction.

In the present embodiment, for example, the diameter of the first changing roller 67 can be greater than or equal to two inches. Thus, in the present embodiment, the curvature radius of the medium 2 bent at the first changing roller 67 can be made relatively large. Therefore, according to the study of the inventor of the present application, in the present embodiment, even if the medium 2 is bent by the first changing roller 67, the occurrence of cracks in the foil transferred to the medium 2 can be suppressed. In particular, in the present embodiment, since the diameter of the first changing roller 67 is greater than or equal to 3 inches, even if the medium 2 is bent by the first changing roller 67, the occurrence of cracks in the foil transferred to the medium 2 can be more effectively suppressed.

(19) The foil transfer device 1 includes, as a moving direction changing roller, a second changing roller 68 for guiding the medium 2 after passing through the first changing roller 67 in a predetermined direction. The medium 2 and the foil transfer sheet 3 are separated when passing through the second changing roller 68.

That is, the medium 2 and the foil transfer sheet 3 overlap each other between the transfer roller pair 8 and the second changing roller 68 in the conveyance direction of the medium 2. Therefore, in the present embodiment, a space for moving the medium 2 and the foil transfer sheet 3 can be reduced between the transfer roller pair 8 and the second changing roller 68 in the conveyance direction of the medium 2.

(20) In the foil transfer device 1, the moving direction changing portion 11 includes a guide roller 69 for guiding the foil transfer sheet 3 that has passed through the second changing roller 68 and separated from the medium 2 in a predetermined direction.

Thus, in the present embodiment, the foil transfer sheet 3 separated from the medium 2 can be appropriately guided in a predetermined direction. If the position of the guide roller 69 is adjustable, the angle θ formed by the medium 2 separated by passing through the second changing roller 68 and the foil transfer sheet 3 can be adjusted by adjusting the position of the guide roller 69 as described above.

(21) In the foil transfer device 1, the medium 2 in a state of overlapping the foil transfer sheet 3 is in contact with the outer peripheral surface of the second changing roller 68.

That is, the medium 2 and the foil transfer sheet 3 separate at a position where the foil transfer sheet 3 separate from the second changing roller 68. Therefore, in the present embodiment, even if the outer diameter of the winding roll 34 fluctuates, the medium 2 and the foil transfer sheet 3 can be separated at a certain position as described above.

(22, 23) In the foil transfer device 1, when viewed from the width direction of the medium 2, the medium 2 separated from the foil transfer sheet 3 linearly extends in a predetermined direction from the second changing roller 68, and the foil transfer sheet 3 separated from the medium 2 linearly extends in a predetermined direction from the second changing roller 68. When viewed from the left-right direction (Y direction), an angle θ formed by the medium 2 separated by passing through the second changing roller 68 and the foil transfer sheet 3 is an acute angle.

Therefore, in the present embodiment, the foil can be appropriately transferred to the portion of the medium 2 to which the adhesive is applied. In particular, in the present embodiment, since the angle θ is less than or equal to 60°, the foil can be more appropriately transferred to the portion of the medium 2 to which the adhesive is applied.

### OTHER EMBODIMENTS

The embodiment described above is an example of a preferred embodiment of the present invention, but the present invention is not limited thereto, and various modified examples can be made without a scope of not changing the gist of the present invention.

In the embodiment described above, the moving direction changing portion 11 may not include the guide roller 69. In the embodiment described above, the moving direction changing portion 11 may not include the second changing roller 68. In this case, when passing through the first changing roller 67, the medium 2 and the foil transfer sheet 3 in the overlapping state are separated. In this case, since the medium 2 and the foil transfer sheet 3 separate at the position where the medium 2 separates from the first changing roller 67, the position where the medium 2 and the foil transfer sheet 3 separate varies according to the outer diameter of the winding roll 34. In this case, since the medium 2 and the foil transfer sheet 3 overlap each other between the transfer roller pair 8 and the first changing roller 67, a space for moving the medium 2 and the foil transfer sheet 3 can be reduced between the transfer roller pair 8 and the first changing roller 67.

When the moving direction changing portion 11 does not include the second changing roller 68, and the medium 2 and the foil transfer sheet 3 in the overlapping state separate when passing through the first changing roller 67, the medium 2 may be disposed on the front side of the foil transfer sheet 3 between the conveying roller 43 and the foil transfer roller 44. The conveying roller 38 and the pad roller 39 may be disposed on the lower side of the winding roll 34. In this case, the medium 2 overlapping the foil transfer sheet 3 is in contact with the outer peripheral surface of the first changing roller 67, and the medium 2 and the foil transfer sheet 3 separate at a position where the foil transfer sheet 3 separates from the first changing roller 67. Therefore, in the present embodiment, even if the outer diameter of the winding roll 34 fluctuates, the medium 2 and the foil transfer sheet 3 can be separated at a certain position as described above.

In the embodiment described above, the foil transfer roller 44 may face the conveying roller 43 from the obliquely front upper side, or may face the conveying roller 43 from the obliquely front lower side. Furthermore, in the embodiment described above, the medium winding portion 17 may be disposed on the lower side of the adhesive application mechanism 5. In this case, the medium winding portion 17 is, for example, attached to the supporting body 6. In the embodiment described above, the medium feeding portion 16 may be disposed on the back side of the adhesive application mechanism 5.

In the embodiment described above, the foil transfer roller 44 may include three divided rollers 46 divided in the left-right direction. Furthermore, in the embodiment described above, the intermediate portion of the divided roller 46 may not be supported by the intermediate supporting member 49 as long as the deflection of the divided roller 46 can be suppressed. Furthermore, in the embodiment described above, the foil transfer roller 44 may be configured by one roller as long as the deflection of the foil transfer roller 44 can be suppressed.

In the embodiment described above, the foil transfer device 1 may not include the second heater 15. In the embodiment described above, the foil transfer device 1 may not include the movement direction changing portion 11. In this case, for example, the medium 2 and the foil transfer sheet 3 separate when passing through the transfer roller pair 8. Furthermore, in the embodiment described above, the tension bar 9 may be biased by a spring member other than the tension coil spring 54.

In the embodiment described above, as long as the foil can be appropriately transferred to the portion of the medium 2 to where the adhesive is applied, the angle θ formed by the medium 2 separated by passing through the second changing roller 68 and the foil transfer sheet 3 may be a right angle or an obtuse angle. Furthermore, in the embodiment described above, the diameter of the first changing roller 67 may be less than two inches as long as the occurrence of cracks of the foil transferred to the medium 2 can be suppressed. Furthermore, in the embodiment described above, the adhesive application mechanism 5 may apply the adhesive to the medium 2 by a method other than the inkjet method.

### REFERENCE SIGNS LIST

1 Foil transfer device
2 Medium
3 Foil transfer sheet (sheet)
5 Adhesive application mechanism (application mechanism)
6 Supporting body
8 Transfer roller pair (roller)
9 Tension bar
10 Tension application mechanism
14 First heater
15 Second heater
16 Medium feeding portion
17 Medium winding portion
18 Sheet feeding portion
23 Head (inkjet head) (head portion)
27 Platen (medium mounting portion)
40 Foil transfer unit
43 Conveying roller
44 Foil transfer roller
46 Divided roller
47 Bearing
49 Intermediate supporting member
Y Width direction of medium, axial direction of foil transfer roller

1. A foil transfer device comprising:
an application mechanism, configured to apply an adhesive to a medium; and
a roller, configured to press a sheet in which a foil is formed on a substrate against the medium to which the adhesive is applied to transfer the foil to the medium;
wherein
the application mechanism includes: a head portion configured to eject the adhesive onto the medium, and a medium mounting portion configured to be disposed on a lower side of the head portion and on which the medium is mounted;
wherein the roller is disposed on a lower side of the medium mounting portion.

2. The foil transfer device as set forth in claim 1, wherein
the roller includes a pair of rollers sandwiching the medium and the sheet, and
the pair of rollers is arranged facing each other in a direction orthogonal to a vertical direction.

3. The foil transfer device as set forth in claim 1, further comprising:
a medium feeding portion, configured to feed the medium to the application mechanism; and
a medium winding portion, configured to wind the medium that has passed through the roller,
wherein
at least one of the medium feeding portion and the medium winding portion is disposed on the lower side of the application mechanism.

4. The foil transfer device as set forth in claim 1, further comprising:
a tension application mechanism, including a tension bar that comes into contact with the medium to which the adhesive is applied to apply a tension to the medium;
wherein the tension bar is disposed between the medium mounting portion and the roller in a vertical direction.

5. The foil transfer device as set forth in claim 4, further comprising:
a first heater and a second heater that heat the medium;
wherein
the first heater is disposed on an upper side of the tension bar, and
the second heater is disposed between the tension bar and the roller in the vertical direction.

6. The foil transfer device as set forth in claim 1, further comprising:
a sheet feeding portion, configured to feed the sheet with respect to the roller; and
a supporting body, configured to support the medium mounting portion from below;
wherein
the sheet feeding portion is detachably attached to the supporting body.

7. The foil transfer device as set forth in claim 1, wherein
the roller includes: a conveying roller that comes into contact with the medium and conveys the medium, and a transfer roller that is biased toward the conveying roller and sandwiches the medium and the sheet with the conveying roller,
the transfer roller includes a plurality of divided rollers divided in an axial direction of the transfer roller, and
each of both end sides of the plurality of divided rollers is rotatably supported by a bearing.

8. The foil transfer device as set forth in claim 7, further comprising:
an intermediate supporting member, configured to rotatably support an intermediate portion of the divided roller.

9. A foil transfer device comprising:
an application mechanism, configured to apply an adhesive to a medium;
a roller, configured to press a sheet in which a foil is formed on a substrate against the medium to which the adhesive is applied to transfer the foil to the medium; and
a tension application mechanism, including a tension bar that comes into contact with the medium to apply tension to the medium;
wherein
the tension bar is disposed between the application mechanism and the roller.

10. The foil transfer device as set forth in claim 9, wherein
the application mechanism includes a head portion that ejects the adhesive onto the medium.

11. The foil transfer device as set forth in claim 9, wherein
the application mechanism is configured to apply the adhesive to one portion of one surface of the medium in a width direction of the medium,
a non-application region where the adhesive is not applied in the width direction of the medium is formed on the one surface,
the tension bar includes a contact portion that comes into contact with the non-application region and a bar main body that holds the contact portion, and
in the tension bar, only the contact portion is in contact with the medium.

12. The foil transfer device as set forth in claim 9, wherein
the medium before the adhesive is applied and the medium after the foil is transferred are wound in a roll shape, and
the sheet before the foil is transferred to the medium is wound in a roll shape.

13. The foil transfer device as set forth in claim 9, further comprising:
a direction changing roller, configured to change a moving direction of the medium in a state of overlapping with the sheet after passing through the roller,
wherein
the direction changing roller changes a moving direction of the medium to a direction different from a moving direction of the medium from the roller to the direction changing roller.

14. The foil transfer device as set forth in claim 13, wherein
the medium and the sheet are separated when passing through the direction changing roller.

15. A foil transfer device comprising:
an application mechanism, configured to apply an adhesive to a medium;
a roller, configured to press a sheet in which a foil is formed on a substrate against the medium to which the adhesive is applied to transfer the foil to the medium; and
a direction changing roller, configured to change a moving direction of the medium in a state of overlapping with the sheet after passing through the roller;
wherein
the direction changing roller changes a moving direction of the medium to a direction different from a moving direction of the medium from the roller to the direction changing roller.

16. The foil transfer device as set forth in claim 15, further comprising:
a first changing roller, configured to bend the medium in a predetermined direction as the direction changing roller.

17. (canceled)

18. (canceled)

19. The foil transfer device as set forth in claim 16, further comprising:
a second changing roller, configured to guide the medium after passing through the first changing roller in a predetermined direction as the direction changing roller, and
the medium and the sheet are separated when passing through the second changing roller.

20. The foil transfer device as set forth in claim 19, further comprising:
a guide roller, configured to guide the sheet that has passed through the second changing roller and separated from the medium in a predetermined direction.

21. (canceled)

22. The foil transfer device as set forth in claim 19, wherein
when viewed in a width direction of the medium, the medium separated from the sheet linearly extends in a predetermined direction from the second changing roller, the sheet separated from the medium linearly extends in a predetermined direction from the second changing roller, and an angle formed by the separated medium and the sheet is an acute angle.

23. The foil transfer device as set forth in claim 22, wherein
when viewed in the width direction of the medium, an angle formed by the separated medium and the sheet is less than or equal to 60°.

24. (canceled)
